(19) United States
(12) Patent Application Publication
(10) Pub. No.: US 2007/0269689 A1
(43) Pub. Date: Nov. 22, 2007

(54) INTEGRATED FUEL RECYCLING MODULE FOR USE IN FUEL CELL SYSTEM AND FUEL CELL SYSTEM USING THE SAME

(75) Inventors: MING ZI HONG, YONGIN-SI (KR); YASUKI YOSHIDA, YONGIN-SI (KR); EUN SUK CHO, YONGIN-SI (KR); HO JIN KWEON, YONGIN-SI (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., SUWON-SI (KR)

(21) Appl. No.: 11/740,780

(22) Filed: Apr. 26, 2007

(30) Foreign Application Priority Data
May 19, 2006 (KR) 10-2006-0044994

(51) Int. Cl. H01M 8/04

(52) U.S. Cl. 429/17; 429/34

(57) ABSTRACT

Disclosed is a fuel feeder housing having a mixing tank and a carbon dioxide remover supporting operation of a fuel cell are formed as a single body. A peripheral module having the fuel feeder housing and a pump are modularized, thereby consulting the compactness and the light weight and enhancing the efficiency of the fuel cell. The fuel feeder housing is coupled to a fuel cartridge storing hydrogen-containing fuel and to a fuel cell that generates electricity through an electrochemical reaction between the fuel and an oxidant. The fuel feeder includes a base member in which a chamber for recycling unreacted fuel discharged from the fuel cell and first and second connecting portions for flowing fluid in and out the chamber therethrough are internally formed as a single body and a gas-liquid separator installed in an opening of the chamber and discharging gas from the chamber.

### CROSS-REFERENCE TO RELATED APPLICATIONS

This application claims the benefit of Korean Patent Application No. 10-2006-0044994, filed on May 19, 2006, in the Korean Intellectual Property Office, the disclosure of which is incorporated herein by reference in its entirety.

### BACKGROUND

1. Field of the Invention

The present invention relates to a fuel cell system, and more particularly, a fuel feeding module.

2. Discussion of Related Art

As technological fields such as electronics, telecommunications and semiconductor engineering, etc. have recently been rapidly developed, a portable electronic apparatus such as a cellular phone, a notebook computer and a personal digital assistant (PDA), and a wire/wireless telecommunication network such as an Internet and digital multi-media broadcasting (DMB) have become internationally widespread. The portable electronic apparatus allows a subscriber to enjoy multimedia such as a movie anytime and anywhere irrespective of time and place. Therefore, there is needed a power supply which is capable of supplying electric power to the portable electronic apparatuses for a long time. For that reason, a direct methanol fuel cell has been attracted attention as one of the power supply.

The direct methanol fuel cell (DMFC) includes a polymer electrolyte membrane such as perfluoro polymer having good conductivity of hydrogen ions, and anode and cathode electrodes adhered to opposite sides of the electrolyte membrane. The direct methanol fuel cell generates electricity through an electrochemical reaction between fuel such as methanol or the like supplied to the anode electrode and an oxidant such as air (oxygen) supplied to the cathode electrode. In the DMFC, an organic fluid fuel such as methanol is directly supplied to the anode electrode, so that a fuel reformer or the like is not needed. Therefore, the fuel cell system like the DMFC has advantages in that it can be easily configured and small in size as compared with other fuel cell systems.

In the DMFC, the electrochemical reaction between the anode electrode and the cathode electrode is as follows:

[Reaction Formula 1]

Anode: CH₃OH+H₂O→CO₂+6H⁺+6e⁻

Cathode: O₂+4H⁺+4e⁻→2H₂O

Meanwhile, because the DMFC directly supplies the liquid fuel to the anode electrode, so that its fuel consumption and output efficiency are relatively low as compared with other fuel cell systems. Accordingly, there has been proposed technology that unreacted fuel not reacted in the DMFC and discharged is circulated and recycled. For example, in most of the DMFC systems, the unreacted fuel except byproducts such as carbon dioxide produced by an oxidation reaction of the fuel among the fluids coming out from the anode electrode is stored in a mixing tank, and the stored unreacted fuel is supplied again to the anode electrode.

However, the DMFC system has to additionally include a carbon dioxide remover to discharge the byproducts such as carbon dioxide in order to enhance the efficiency of the system; a mixing tank; and a pump for supplying the unreacted fuel to the anode electrode. Therefore, the size of the DMFC system becomes large, so that it has difficulty in being applying to a portable apparatus.

The foregoing discussion is to provide background information of fuel cell systems, and does not constitute an admission of prior art.

### SUMMARY OF CERTAIN INVENTIVE ASPECTS

An aspect of the invention provides an integrated fuel recycling module for use in a fuel cell system, which may comprise: a fuel recycler comprising an inlet opening and an outlet opening, wherein the fuel recycler is configured to receive via the inlet opening a mixture comprising an unused fuel and resultants of a fuel cell reaction, wherein the fuel recycler is configured to collect at least part of the unused fuel from the mixture and further configured such that the collected fuel is discharged via the outlet opening; and a solid body integrated with the fuel recycler and comprising a first channel formed in the solid body, the first channel comprising a first opening and a second opening, wherein the first opening is connectable to one of the inlet and outlet openings, wherein the second opening is connectable to a fuel cell and configured to receive the mixture from the fuel cell or to supply the collected fuel to the fuel cell.

In the foregoing module, the first opening may be connectable to the inlet opening via a tubing, wherein the second opening may be connectable to the fuel cell and configured to receive the mixture from the fuel cell. The first opening may be connectable to the outlet opening via a tubing, wherein the second opening may be connectable to the fuel cell and configured to supply the collected fuel to the fuel cell. The module may further comprise a pump connected to the first opening and the outlet opening, wherein the pump may be configured to form a fluid communication between the first opening and the outlet opening. The module may further comprise a second channel formed in the solid body and comprising a first opening and a second opening, wherein the first opening of the second channel may be connectable to the inlet opening via a tubing, wherein the second opening of the second channel may be connectable to the fuel cell and configured to receive the mixture from the fuel cell. The module may further comprise a pump connected to the outlet opening and the first opening of the second channel, wherein the pump may be configured to form a fluid communication between the outlet opening and the first opening of the second channel.

Still in the foregoing module, the fuel recycler may further comprise another inlet opening, wherein the module may further comprise a second channel formed in the solid body and comprising a first opening and a second opening, wherein the first opening of the second channel may be connectable to the other inlet opening via a tubing, wherein the second opening of the second channel may be connectable to a fuel cartridge and configured to receive non-recycled fuel. The module may further comprise a pump connected to the other inlet opening and the first opening of the second channel, wherein the pump may be configured to form a fluid communication between the other inlet opening and the first opening of the second channel. The module may further comprise a second channel and a third channel, wherein the second channel may be formed in the solid body and comprises a first opening and a second opening, wherein the third channel may be formed in the solid body and comprises a first opening, a second opening and a third opening, wherein the second opening of the second channel may be connectable to a fuel cartridge and configured to receive non-recycled fuel, wherein the first opening of the third channel may be connectable to the first opening of the first channel via a tubing, the second opening of the third channel may be connectable to the first opening of the second channel via a tubing, and the third opening of the third channel may be in fluid communication with the outlet opening. The module may further comprise a pump connected to the first opening of the first channel and the first opening of the third channel, wherein the pump may be configured to form a fluid communication between the first opening of the first channel and the first opening of the third channel. The module may further comprise a pump connected to the first opening of the second channel and the second opening of the third channel, wherein the pump may be configured to form a fluid communication between the first opening of the second channel and the second opening of the third channel. The non-recycled fuel may not substantially flow into the fuel recycler.

Further in the foregoing method, the fuel recycler may further comprise another opening, wherein the opening may be configured to receive the mixture from an anode of the fuel cell and the other opening is configured to receive the mixture from a cathode of the fuel cell. The module may further comprise a vent formed in the solid body and a gas-permeable liquid-impermeable material, wherein the vent connects the fuel recycler and the outside of the solid body, and wherein the a gas-permeable liquid-impermeable material is located between the fuel recycler and the outside of the solid body.

Another aspect of the invention provides a fuel cell system, which may comprise: the foregoing module; and a fuel cell operably connected to the module. In the above system, the fuel may comprise liquid at room temperature. The fuel may comprise at least one selected from the group consisting of methanol, ethanol, propyl alcohol, butyl alcohol, liquefied hydrogen, naphtha, liquefied petroleum gas and gasoline.

Still another aspect of the invention provides a method of recycling fuel in a fuel cell system, which may comprise: providing the module of claim 1 and a connector forming fluid communication between the first opening and the outlet opening; receiving the mixture via the inlet opening from the fuel cell; and supplying the collected fuel to the fuel cell via the first channel.

In the foregoing method, the connector may comprise a pump connected to the first opening and the outlet opening, and wherein the pump may be configured to form fluid communication between the first opening and the outlet opening. The fuel recycler may further comprise another inlet opening, wherein the module may further comprise a second channel formed in the solid body and comprising a first opening and a second opening, wherein the first opening of the second channel may be connectable to the other inlet opening via a tubing, wherein the second opening of the second channel may be connectable to a fuel cartridge and configured to receive non-recycled fuel; and wherein the method may further comprise providing another connector forming fluid communication between the first opening of the second channel and the other inlet, and receiving the non-recycled fuel via the other inlet from the fuel cartridge.

An aspect of the present invention provides a fuel feeder housing that consults the compactness and the light weight of a fuel cell system to be mounted to a portable electronic apparatus while keeping the efficiency of the fuel cell system high.

Another aspect of the present invention provides a peripheral module that modularizes peripheral units using the foregoing fuel feeder housing and supporting the fuel cell.

The still another aspect of the present invention provides a fuel feeder housing coupled to a fuel cartridge storing hydrogen-containing fuel and to a fuel cell that generates electricity through an electrochemical reaction between the fuel and an oxidant, the fuel feeder housing including: a base member in which a chamber for recycling unreacted fuel discharged from the fuel cell and first and second connecting portions for flowing fluid in and out the chamber therethrough are internally formed as a single body; and a gas-liquid separator installed in an opening of the chamber and discharging gas from the chamber.

Another aspect of the present invention provides a peripheral module including: a fuel feeder housing that is coupled to a fuel cartridge storing hydrogen-containing fuel and to a fuel cell that generates electricity through an electrochemical reaction between the fuel and an oxidant, and includes: a base member in which a chamber for recycling unreacted fuel discharged from the fuel cell and first and second connecting portions for flowing fluid in and out the chamber therethrough are internally formed as a single body, and a gas-liquid separator installed in an opening of the chamber and discharging gas from the chamber; and a pump attached to an external surface of the fuel feeder housing by a holding unit, coupled to the middle of the second connecting portion, and supplying the fuel stored in the chamber to the fuel cell.

### BRIEF DESCRIPTION OF THE DRAWINGS

These and other aspects and advantages of the invention will become apparent and more readily appreciated from the following description of the embodiments, taken in conjunction with the accompanying drawings of which:

FIG. 1 is a plan view of a fuel feeder housing according to an embodiment of the present invention;

FIG. 2A is a plan view of a connector coupled to the fuel feeder housing of FIG. 1;

FIG. 2B is a photograph showing that the fuel feeder housing of FIG. 1 and a fuel cartridge are mounted to an application;

FIG. 3 is a photograph showing a peripheral module using the fuel feeder housing of FIG. 1;

FIG. 4 is a block diagram of a direct methanol fuel cell system employing a peripheral module according to an embodiment of the present invention;

FIG. 5 is a plan view of a fuel feeder housing according to an embodiment of the present invention; and

FIG. 6 is a block diagram of a direct methanol fuel cell system employing a peripheral module using the fuel feeder housing of FIG. 5.

### DETAILED DESCRIPTION OF EMBODIMENTS

Hereinafter, various embodiments of the present invention will be described with reference to accompanying drawings, wherein like numerals refer to like elements throughout.

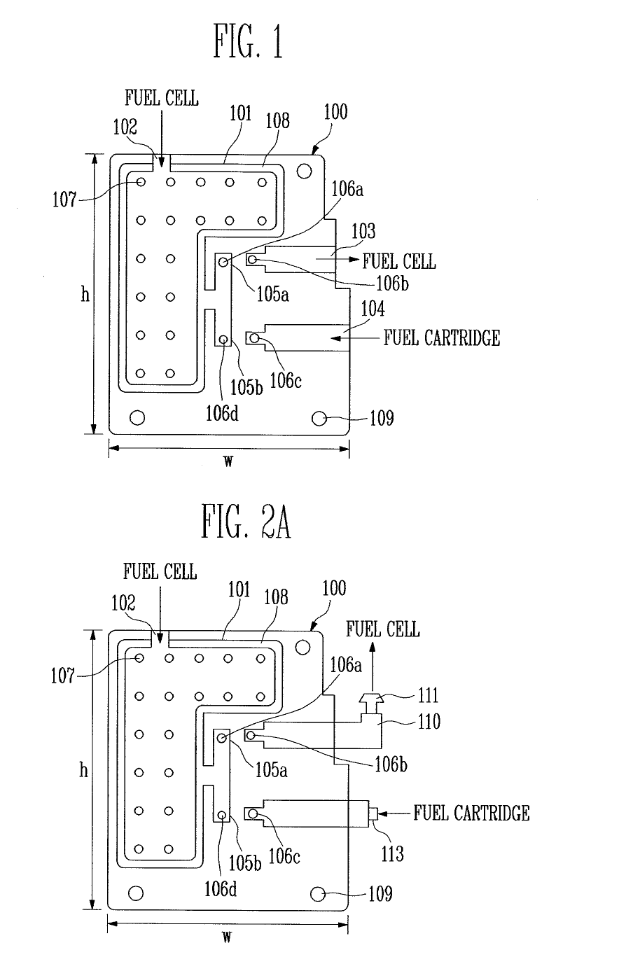

FIG. 1 is a plan view of a fuel feeder housing according to an embodiment of the present invention. Referring to FIG. 1, a fuel feeder housing 100 according to the illustrated embodiment of the present invention includes a chamber 101 connected to a fuel cell and a fuel cartridge to store fuel to be used in the fuel cell, and storing and recycling unreacted fuel unused in and discharged from the fuel cell; a first connecting portion 102 and second connecting portions 103 and 105a through which fluid can flow in and out the chamber 101; and a base member integrally formed with third connecting portions 104 and 105b connecting the fuel cartridge and the fuel cell. Further, the fuel feeder housing 100 includes a gas-liquid separator 108 installed in correspondence to an opening 107 of the chamber 101 and discharging gas from the inside of the chamber 101.

The base member is made of metal having corrosion resistance to fuel such as methanol, ethanol, liquefied hydrogen, naphtha, liquefied petroleum gas, etc. or a thermoplastic resin such as polycarbonate, Peek, etc. In the discussed or other embodiments, the base member has a shape to be fitted to an installation region, i.e., a dead volume of the application. In this embodiment, the base member has a height of about 6.5 cm, a width of about 4.5 cm and a thickness of about 0.8 cm to achieve the compactness and the light weight thereof. Further, the base member is formed with a hole, i.e., an opening 107 to discharge undesired gas, e.g., carbon dioxide among fluids introduced into the chamber 101.

The chamber 101 occupies an inner whole region of the base member except the connecting portions 102, 103, 104, 105a and 105b and a fastening hole 109 for settling the base member. For example, the camber 101 has a curved-shape. The shape of the chamber 101 is formed by bending the chamber 101 at a predetermined angle (e.g., a right angle) in consideration of positions of the connecting portions 102, 103, 104, 105a and 105b such that the chamber 101 fully occupies the inside of the base member. Alternatively, the chamber 101 may be bent once or many times. Further, the shape of the chamber 101 may be varied in correspondence to shapes of the dead volume.

Further, the chamber 101 includes the first connecting portion 102 into which unreacted fuel is introduced from the fuel cell; the second connecting portions 105a and 103 to circulate the stored fuel toward the fuel cell; and the third connecting portions 104 and 105b to receive hydrogen-containing fuel from the fuel cartridge. Here, the hydrogen-containing fuel includes methanol, ethanol, liquefied hydrogen, naphtha, desulfurized gasoline, liquefied petroleum gas, etc.

The gas-liquid separator 108 serves to discharge the undesired gas such as carbon dioxide except the unreacted fuel or water introduced into the chamber 101. The gas-liquid separator 108 has an opening corresponding to the first connecting portion 102 to do not obstruct the first connecting portion 102, and installed in an inner wall of the chamber 101. Meanwhile, the gas-liquid separator 108 is made of a porous material absorbing the liquid fuel to smoothly circulate the unreacted fuel even though the fuel feeder housing 100 leans in any direction. Particularly, the gas-liquid separator 108 is made of a hydrophobic porous material that can be loaded with the fuel but not physically or chemically reacted with the fuel. For example, the gas-liquid separator 108 is made of a porous material coated with a hydrophobic material and having a pore size of about 10 μm. Alternatively, the gas-liquid separator 108 may be provided on the whole inner wall of the chamber 101.

The first connecting portion 102 serves as a passage to introduce the unreacted fuel and water from the fuel cell into the chamber 101, and is connected to an anode outlet of the fuel cell via the minimum pipe arrangement. The second connecting portions 105a and 103 serve as passages to supply the unreacted fuel stored in the chamber 101 to the fuel cell. Between the second connecting portions 105a and 103 are formed two connecting holes 106a and 106b to be connected to a first pump (hereinafter, referred to as an “introducing pump”). The third connecting portions 104 and 105b serve as passages to supply the fuel stored in the fuel cartridge to the fuel cell. Between the third connecting portions 104 and 105b are formed two connecting holes 106c and 106d to be connected to a second pump (hereinafter, referred to as a “fuel pump”). In other words, the connecting portions are isolated in the middle thereof and separated into two connecting portions, respectively. Also, two connecting portions are formed with connecting holes in positions thereof facing each other, respectively. Each connecting hole penetrates the base member and communicates with the outside. Two connecting holes provided in each of the second and third connecting portions allow an inlet and an outlet of the pump to be inserted therein without additional pipes. Meanwhile, the second connecting portion and the third connecting portion are placed in a bent region, i.e., an interior angle region of the chamber 101 having the curved-shape, thereby consulting the compactness of the housing.

According to the illustrated embodiment, the second and third connecting portions are connected to the chamber 101 as being combined as a single channel. In this case, the fuel supplied from the fuel cartridge is mixed with the unreacted fuel not in the chamber 101 but while passing through the second connecting portions 105a and 103, and then supplied to the fuel cell. Through the fastening hole 109, a holding unit such as a screw or the like passes so that the fuel feeder housing 100 is fastened to the application such as a portable electronic apparatus. Alternatively, the fastening hole 109 may be replaced by a proper means as long as it can fasten the fuel feeder housing 100 to the application.

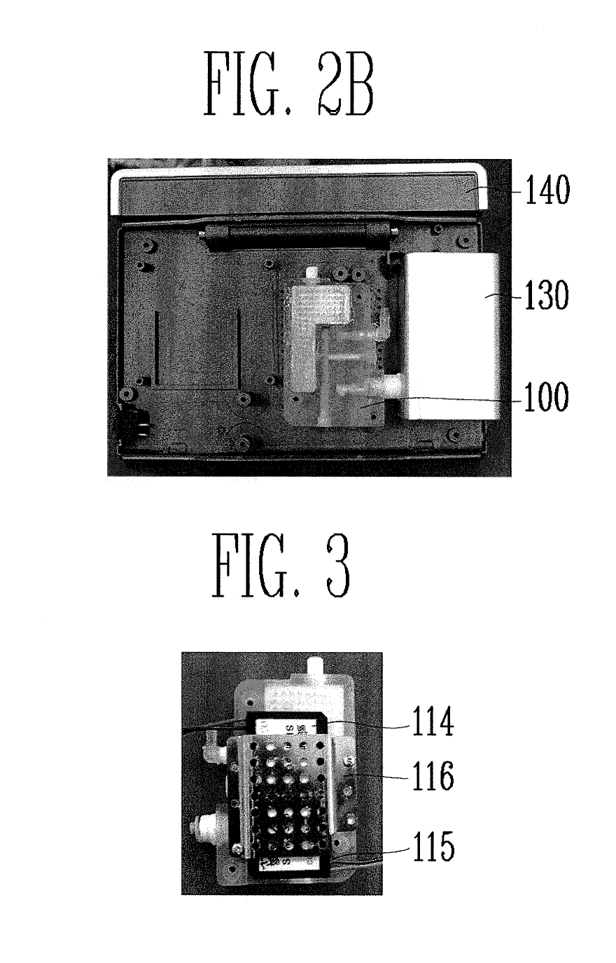

FIG. 2A is a plan view of a connector coupled to the fuel feeder housing of FIG. 1. Referring to FIG. 2A, the fuel feeder housing or fuel recycling module according to one embodiment of the present invention further includes a first connector 110 connected to the second connecting portion 103 and a second connector 112 connected to the third connecting portion 104 in addition to the foregoing configuration of the fuel feeder housing. The first connector 110 serves to be readily coupled with a pipe connecting the fuel feeder housing 100 and the fuel cell. Thus, an end 111 of the first connector 110 has a structure to easily insert and hold the pipe. The second connector 112 serves to connect the fuel feeder housing 100 and the fuel cartridge. To easily connect the fuel feeder housing 100 and the fuel cartridge, an end 113 of the second connector 113 protrudes from a surface of the base member to be inserted in and held by the fuel cartridge. For example, the first connector 110 can be achieved by a nozzle that allows the fuel stored in the fuel cartridge to be discharged only after being coupled to the outlet of the fuel cartridge.

FIG. 2B is a photograph showing that the fuel feeder housing of FIG. 1 and a fuel cartridge are mounted to an application. In the illustrated embodiment, a portable multimedia player (PMP) having a size of about 15 cm×10 cm will be described as an example of the application. In FIG. 2B, the PMP is illustrated without a top plate mounted with a controller and a display unit. The fuel feeder housing 100 mounted to the application is installed by utilizing the dead volume of an application main body. As shown in FIG. 2B, the fuel feeder housing 100 is coupled to the fuel cartridge 130 provided inside the main body and placed in the dead volume of the middle of the main body. In this embodiment, wiring lines between the fuel feeder housing 100 and a fuel cell stack 140 provided on the main body are omitted. For example, using the fuel feeder housing 100 according to the illustrated or other embodiment of the present invention and a methanol cartridge of 20 cc, the PMP can be driven for four hours with a rated output of 5 W and for eight hours or more with a rated output of 8 W. Thus, the compactness and the light weight of the PMP are achieved.

In FIG. 2B, the connecting portions of the fuel feeder housing are formed to be obstructed by a predetermined finishing material at the other portions except portions corresponding to the first, second and third connecting portions 102, 103, 104, 105a and 105b shown in FIG. 2A. Therefore, it is possible to obstruct channels unnecessarily formed when the connecting portions of the fuel feeder housing 100 are formed by a tool such as a drill.

FIG. 3 is a photograph showing a peripheral module using the fuel feeder housing of FIG. 1. As shown in FIG. 3, a peripheral module according to the illustrated embodiment of the present invention includes an introducing pump 114 and a fuel pump 115 attached to one surface thereof. The introducing pump 114 and the fuel pump 115 are closely attached to the base member by a holding unit 116. The introducing pump 114 is a small pump to introduce the fuel to the fuel cell, and the fuel pump 115 is also a small pump to supply the fuel stored in the fuel cartridge to the chamber or the fuel cell. In this embodiment, each of the introducing pump 114 and the fuel pump 115 has a size of about 3.5 cm×3.5 cm, and a maximum output capacity of about 5 cc/min.

The holding unit 116 is used in closely attaching the introducing pump 114 and the fuel pump 115 to the base member. The holding unit 116 is attached to the base member by a screw or the like. The holding unit 116 can be achieved by a heat sink that is made of metal having high heat conductivity and formed with a plurality of holes through which heat generated from the introducing pump 114 and the fuel pump 115 is radiated.

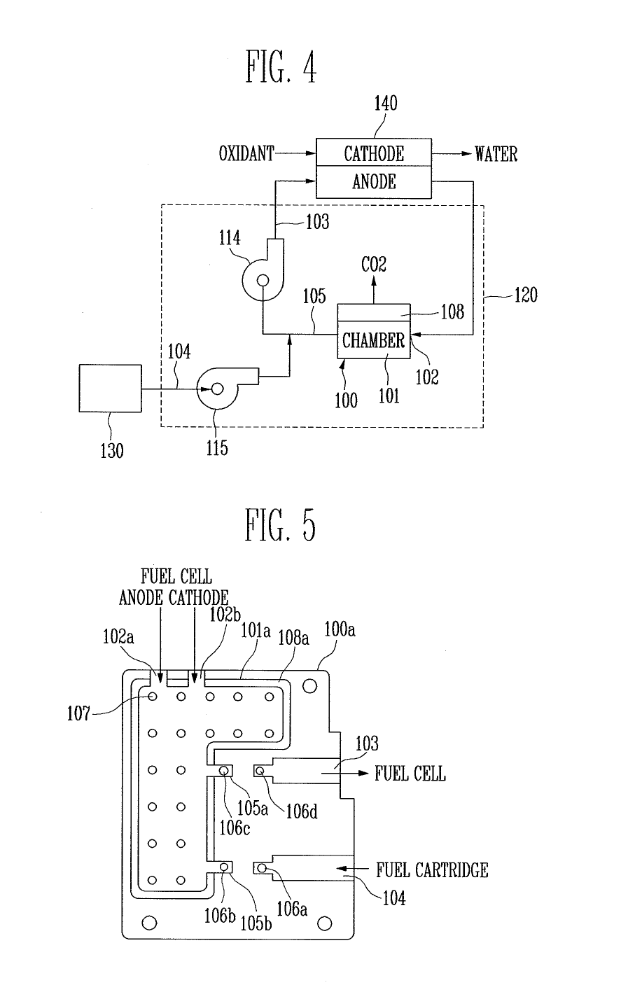

FIG. 4 is a block diagram of a direct methanol fuel cell system employing a peripheral module according to the illustrated embodiment of the present invention. Referring to FIG. 4, the peripheral module 120 according to an embodiment of the present invention includes the chamber 101 internally provided with the gas-liquid separator 108 to discharge carbon dioxide to consult the compactness and the light weight of the system while enhancing the direct methanol fuel cell 140; the connecting portions 102, 103, 104 and 105 to be connected with the fuel cell 140 or the fuel cartridge 130; the fuel feeder housing 100 having connectors integrally formed in the single base member so as to be easily coupled with the fuel cell 140 or the fuel cartridge 130; and the pumps 114 and 115 attached to the external surface of the fuel feeder housing 100 and directly connected to the middles of the second and third connecting portions, respectively.

According to the illustrated and other embodiments of the present invention, the peripheral module 120 is achieved by modularizing all peripheral units except the fuel cartridge, which support the operation of the fuel cell 140, in order to consult the compactness and the light weight of a small fuel cell system mounted to the portable electronic apparatus. For example, the existing mixing tank, the carbon dioxide remover and the connecting pipes are modularized in the housing, and the inlet and the outlet of the pump are inserted through the connecting holes formed in the connecting portions of the housing without additional pipes.

Below, operations of the fuel cell system using the peripheral module according to the illustrated embodiment of the present invention will be schematically described. First, when the peripheral module 120 connected to the fuel cartridge 130 and the fuel cell 140 starts operating, the unreacted fuel stored in the chamber 101 is supplied by the introducing pump 114 to the fuel cell 140 through second connecting portions 105 and 103. At this time, the high concentration fuel stored in the fuel cartridge 130 is supplied by the fuel pump 115 and the introducing pump 114 to the fuel cell 140 through the third connecting portion s 104 and 105 and the second connecting portions 105 and 103.

The fuel supplied from the chamber 101 and the fuel supplied from the fuel cartridge 130 are mixed to have proper concentration while passing through the second connecting portion 103. Further, the unreacted fuel, water, carbon dioxide, etc. among the fluids discharged from the fuel cell 140 are introduced into the chamber 101 through the first connecting portion 102. On the other hand, gas such as carbon dioxide or the like among the introduced fluids, which is unnecessary for fuel recycle, is discharged to the outside through the gas-liquid separator 108.

As described above, the peripheral module 120 according to the illustrated embodiment of the present invention is mounted to the dead volume of the application, thereby contributing the compactness and the light weight of the application, circulating and recycling the unreacted fuel discharged from the anode electrode of the fuel cell 140, supplying the fuel from the fuel cartridge 130 to the fuel cell 140, and enhancing the efficiency of the fuel cell system.

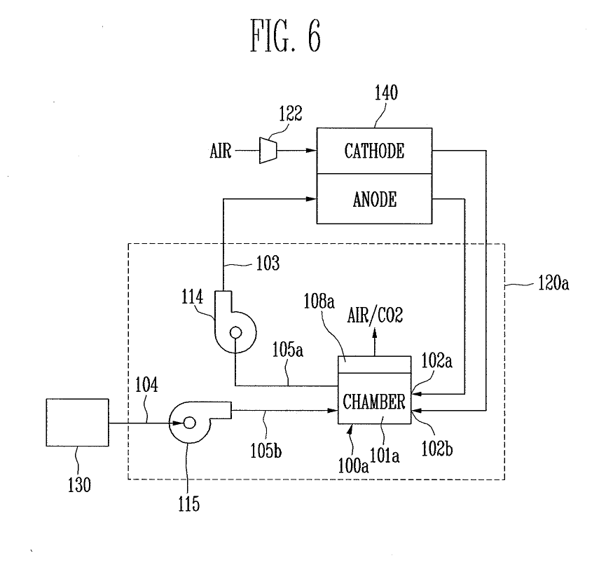

FIG. 5 is a plan view of a fuel feeder housing according to an embodiment of the present invention. Referring to FIG. 5, a fuel feeder housing 100a according to the illustrated embodiment of the present invention includes a chamber 101a connected to a fuel cell and a fuel cartridge to store fuel to be used in the fuel cell, and storing and recycling unreacted fuel unused in and discharged from the fuel cell; first connecting portions 102a and 102b through which fluid is introduced into the chamber 101a; second connecting portions 103 and 105a through which fluid is discharged from the chamber 101a; and a base member integrally formed with third connecting portions 104 and 105b to be connected with the fuel cartridge. Further, the fuel feeder housing 100a includes a gas-liquid separator 108a installed in correspondence to an opening 107 of the chamber 101a and discharging gas from the inside of the chamber 101a.

As compared with the fuel feeder housing 100 according to the first embodiment, in the fuel feeder housing 100a according to the illustrated embodiment, the second connecting portions and the third connecting portions placed in a bent region, i.e., an interior angle region of the chamber 101a having a curved-shape are independently connected to the chamber 101a without being combined as a single channel. Thus, the fuel feeder housing 100a of the illustrated embodiment is different from that of the first embodiment in structure that the fuel is introduced from the fuel cartridge to the chamber 101a and the first connecting portions 102a and 102b are connected to anode and cathode outlets of the fuel cell, respectively.

With this configuration, the fuel supplied from the fuel cartridge to the chamber 101a of the fuel feeder housing 101a through the third connecting portions 104 and 105b is mixed with the unreacted fuel and water discharged from the fuel cell within the chamber 101a, and then the mixed fuel is supplied to the fuel cell through the second connecting portions 105a and 103.

FIG. 6 is a block diagram of a direct methanol fuel cell system employing a peripheral module using the fuel feeder housing of FIG. 5. Referring to FIG. 6, the peripheral module 120a according to the an embodiments of the present invention includes the chamber 101a internally provided with the gas-liquid separator 108a to discharge carbon dioxide to consult the compactness and the light weight of the system while enhancing the direct methanol fuel cell 140; the connecting portions 102, 103, 104, 105a and 105b to be connected with the fuel cell 140 or the fuel cartridge 130; the fuel feeder housing 100a having connectors (not shown) integrally formed in the single base member so as to be easily coupled with the fuel cell 140 or the fuel cartridge 130. Further, the peripheral module 120a includes pumps 114 and 115 attached to the external surface of the fuel feeder housing 100a and directly connected to the middles of the second and third connecting portions, respectively. Further, the fuel cell system according to the illustrated and other embodiment includes an oxidant feeder 122 to supply an oxidant such as air (i.e., oxygen) to a cathode electrode of the fuel cell 140. The oxidant feeder 122 can be achieved by an air pump or a blower.

According to the illustrated embodiment of the present invention, the peripheral module 120a is achieved by modularizing all peripheral units except the fuel cartridge, which support the operation of the fuel cell 140, in order to consult the compactness and the light weight of a small fuel cell system mounted to the portable electronic apparatus. Meanwhile, the peripheral module 120a according to the illustrated embodiment is different from that of the first embodiment in that the fuel stored in the fuel cartridge 130 is introduced into the chamber 101a and then supplied to the fuel cell 140.

Below, operations of the fuel cell system using the peripheral module according to the illustrated embodiment of the present invention will be schematically described. First, the fuel stored in the fuel cartridge 130 is supplied to the chamber 101a of the fuel feeder housing 100a via the third connecting portions 104 and 105b by the fuel pump 1115. The supplied fuel has concentration higher than that of the unreacted fuel stored in the chamber 101a. Further, the fluids such as the unreacted fuel, water, etc. discharged from the anode and cathode electrodes of the fuel cell 140 are introduced into the chamber 101a through two first connecting portions 102a and 102b. On the other hand, unnecessary gas such as carbon dioxide among the introduced fluids is filtered through the gas-liquid separator 108a provided in an inner wall of the chamber 101a, and then discharged to the outside through a discharging hole of the base member. Then, the fuel stored in the chamber 101a, i.e., the mixed fuel of the unreacted fuel and water introduced from the fuel cell 140 and the high concentration fuel introduced from the fuel cartridge 130 is supplied to the anode electrode of the fuel cell 140 via the second connecting portions 105a and 103 by the introducing pump 114. With these processes, the fuel cell 140 electrochemically oxidizes hydrogen contained in the fuel, thereby generating electricity.

In the foregoing fuel feeder housing and the peripheral module using the same, the structure of introducing water discharged from the cathode electrode of the fuel cell into the chamber may be varied according to the amount of unreacted fuel stored in the chamber and the concentration of the fuel supplied from the fuel cartridge. In other words, recycling water discharged from the cathode electrode of the fuel cell can be optionally selected in consideration of the efficiency of driving the system.

Embodiments of the present invention provide the compact and lightweight fuel feeder housing and the peripheral module using the same, which can be used in the fuel feeders for the PMP, a personal digital assistant (PDA), a cellular phone, etc. As described above, the fuel feeder housing and the peripheral module using the same have not only a structure for efficiently driving the fuel cell, in which the peripheral units, e.g., the mixing tank and the carbon dioxide remover are formed as single body, but also a structure for being easily coupled to the fuel cell or the fuel cartridge. Therefore, the fuel feeder housing and the peripheral module using the same can be readily mounted to the dead volume of the portable electronic apparatus, and contribute the compactness and the light weight of the fuel cell system and the portable electronic apparatus to be mounted with the fuel cell system. Further, the fuel feeder housing according to embodiments of the present invention and the peripheral module using the same can support the stable operation of the fuel cell system regardless of the movement and the directionality of the portable electronic apparatus, thereby enhancing the reliability of the fuel cell system and the portable electronic apparatus.

Although various embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An integrated fuel recycling module for use in a fuel cell system, comprising:
a fuel recycler comprising an inlet opening and an outlet opening, wherein the fuel recycler is configured to receive via the inlet opening a mixture comprising an unused fuel and resultants of a fuel cell reaction, wherein the fuel recycler is configured to collect at least part of the unused fuel from the mixture and further configured such that the collected fuel is discharged via the outlet opening; and
a solid body integrated with the fuel recycler and comprising a first channel formed in the solid body, the first channel comprising a first opening and a second opening, wherein the first opening is connectable to one of the inlet and outlet openings, wherein the second opening is connectable to a fuel cell and configured to receive the mixture from the fuel cell or to supply the collected fuel to the fuel cell.

2. The module of claim 1, wherein the first opening is connectable to the inlet opening via a tubing, wherein the second opening is connectable to the fuel cell and configured to receive the mixture from the fuel cell.

3. The module of claim 1, wherein the first opening is connectable to the outlet opening via a tubing, wherein the second opening is connectable to the fuel cell and configured to supply the collected fuel to the fuel cell.

4. The module of claim 3, further comprising a pump connected to the first opening and the outlet opening, wherein the pump is configured to form a fluid communication between the first opening and the outlet opening.

5. The module of claim 3, further comprising a second channel formed in the solid body and comprising a first opening and a second opening, wherein the first opening of the second channel is connectable to the inlet opening via a tubing, wherein the second opening of the second channel is connectable to the fuel cell and configured to receive the mixture from the fuel cell.

6. The module of claim 5, further comprising a pump connected to the outlet opening and the first opening of the second channel, wherein the pump is configured to form a fluid communication between the outlet opening and the first opening of the second channel.

7. The module of claim 3, wherein the fuel recycler further comprises another inlet opening, wherein the module further comprises a second channel formed in the solid body and comprising a first opening and a second opening, wherein the first opening of the second channel is connectable to the other inlet opening via a tubing, wherein the second opening of the second channel is connectable to a fuel cartridge and configured to receive non-recycled fuel.

8. The module of claim 7, further comprising a pump connected to the other inlet opening and the first opening of the second channel, wherein the pump is configured to form a fluid communication between the other inlet opening and the first opening of the second channel.

9. The module of claim 3, further comprising a second channel and a third channel, wherein the a second channel is formed in the solid body and comprises a first opening and a second opening, wherein the third channel is formed in the solid body and comprises a first opening, a second opening and a third opening, wherein the second opening of the second channel is connectable to a fuel cartridge and configured to receive non-recycled fuel, wherein the first opening of the third channel is connectable to the first opening of the first channel via a tubing, the second opening of the third channel is connectable to the first opening of the second channel via a tubing, and the third opening of the third channel is in fluid communication with the outlet opening.

10. The module of claim 9, further comprising a pump connected to the first opening of the first channel and the first opening of the third channel, wherein the pump is configured to form a fluid communication between the first opening of the first channel and the first opening of the third channel.

11. The module of claim 9, further comprising a pump connected to the first opening of the second channel and the second opening of the third channel, wherein the pump is configured to form a fluid communication between the first opening of the second channel and the second opening of the third channel.

12. The module of claim 9, wherein the non-recycled fuel does not substantially flow into the fuel recycler.

13. The module of claim 1, wherein the fuel recycler further comprises another opening, wherein the opening is configured to receive the mixture from an anode of the fuel cell and the other opening is configured to receive the mixture from a cathode of the fuel cell.

14. The module of claim 1, further comprising a vent formed in the solid body and a gas-permeable liquid-impermeable material, wherein the vent connects the fuel recycler and the outside of the solid body, and wherein the gas-permeable liquid-impermeable material is located between the fuel recycler and the outside of the solid body.

15. A fuel cell system comprising:
the module of claim 1; and
a fuel cell operably connected to the module.

16. The system of claim 15, wherein the fuel comprises liquid at room temperature.

17. The system of claim 15, wherein the fuel comprises at least one selected from the group consisting of methanol, ethanol, propyl alcohol, butyl alcohol, liquefied hydrogen, naphtha, liquefied petroleum gas and gasoline.

18. A method of recycling fuel in a fuel cell system, the method comprising:
providing the module of claim 1 and a connector forming fluid communication between the first opening and the outlet opening;
receiving the mixture via the inlet opening from the fuel cell; and
supplying the collected fuel to the fuel cell via the first channel.

19. The method of claim 18, wherein the connector comprises a pump connected to the first opening and the outlet opening, and wherein the pump is configured to form fluid communication between the first opening and the outlet opening.

20. The method of claim 18, wherein the fuel recycler further comprises another inlet opening, wherein the module further comprises a second channel formed in the solid body and comprising a first opening and a second opening, wherein the first opening of the second channel is connectable to the other inlet opening via a tubing, wherein the second opening of the second channel is connectable to a fuel cartridge and configured to receive non-recycled fuel; and
wherein the method further comprising:
providing another connector forming fluid communication between the first opening of the second channel and the other inlet; and
receiving the non-recycled fuel via the other inlet from the fuel cartridge.
